(19) United States
(12) Patent Application Publication
(10) Pub. No.: US 2016/0036718 A1
(43) Pub. Date: Feb. 4, 2016

(54) NETWORK SERVICE ANALYTICS

(71) Applicant: Accenture Global Services Limited, Dublin (IE)

(72) Inventors: Rajan SHINGARI, New Delhi (IN); Kaushik Sanyal, Kolkata (IN); Dimas Hartz Pinto, Rio de Janeiro (BR); Arnab Chakraborty, Frankfurt (DE); Wallace Silva, Rio de Janeiro (BR); Garvit Gupta, Ghaziabad (IN); Shilpa Taneja, Faridabad (IN); Saurabh Mathur, Bangalore (IN); Luiz C. Nunes, Rio de Janeiro (BR); Francisco M. Vasconcelos, Matosinhos (PT); Marco T. Baptista, Rio de Janeiro (BR)

(21) Appl. No.: 14/481,352

(22) Filed: Sep. 9, 2014

(30) Foreign Application Priority Data
Jul. 29, 2014 (IN) 3687/CHE/2014

(51) Int. Cl. H04L 12/911; G06Q 10/06; G06F 17/30; H04L 12/26; H04L 12/24

(52) U.S. Cl. CPC H04L 47/78; H04L 43/08; H04L 41/147; G06F 17/30964; G06Q 10/06393

(57) ABSTRACT

A device may determine a performance metric associated with a network service management process. The device may determine a key question that may identify a business issue associated with improving the performance metric. The device may perform a root cause analysis that identifies a solution to the key question. The solution may identify a manner in which the network service management process is to be modified in order to improve the performance metric. The device may forecast, based on the solution, a network service demand that may identify a quantity of expected future network service actions expected based on implementing the solution. The device may perform, based on the forecasted network service demand, capacity planning that may identify network service resources required to satisfy the forecasted network service demand. The device may schedule the network service resources such that the solution is implemented within the network service management process.

### RELATED APPLICATION

This application claims priority to Indian Patent Application No. 3687/CHE/2014, filed on Jul. 29, 2014, the content of which is incorporated by reference herein in its entirety.

### BACKGROUND

A network service provider (e.g., a telephone service provider, a wireless service provider, an Internet service provider, a television service provider, etc.) may utilize a network service management process in order to resolve customer issues associated with network services (e.g., broadband services, landline services, etc.) provided by the network service provider. The network service management process may include a network services command center working in conjunction with a field force in order to resolve the customer issues.

### SUMMARY

According to some possible implementations, a device may determine a performance metric associated with a network service management process. The performance metric may be determined based on network service information associated with the network service management process. The device may determine a key question, associated with the performance metric, based on determining the performance metric. The key question may identify a business issue associated with improving the performance metric. The device may perform a root cause analysis, associated with the key question, that identifies a solution to the key question. The solution may identify a manner in which the network service management process is to be modified in order to improve the performance metric. The device may forecast a network service demand based on the solution to the key question. The forecasted network service demand may identify a quantity of future network service actions expected based on implementing the solution within the network service management process. The device may perform capacity planning based on the forecasted network service demand. A result of performing the capacity planning may identify network service resources required to satisfy the forecasted network service demand. The device may schedule the network service resources, based on the result of performing capacity planning, such that the solution is implemented within the network service management process.

According to some possible implementations, a method may include determining, by a device, a performance metric associated with a network service management process. The performance metric may be determined based on network service information associated with the network service management process. The method may include identifying, by the device and based on determining the performance metric, a key question associated with the performance metric. The key question may identify a business issue associated with improving the performance metric. The method may include identifying, by the device, an issue tree associated with the key question. The issue tree may include a set of hypotheses associated with the key question. The method may include validating, by the device, a hypothesis, of the set of hypotheses, based on the network service information. The method may include determining, by the device, a solution to the key question based on validating the hypothesis. The solution may identify a manner in which the network service management process is to be modified in order to improve the performance metric. The method may include performing, by the device, a simulation associated with the solution. A result of the simulation may include financial information associated with implementing the solution within the network service management process. The method may include outputting the result of the simulation.

According to some possible implementations, a method may include generating, by a device, a report associated with a network service management process. The report may include information associated with a performance metric associated with the network service management process. The performance metric may be based on network service information associated with the network service management process. The method may include determining, by the device, a key question, associated with the performance metric, based on generating the report. The key question may identify a business issue associated with improving the performance metric. The method may include determining, by the device, an issue tree, corresponding to the key question, that includes a hypothesis associated with the key question. The method may include validating, by the device, the hypothesis. The hypothesis may be validated based on a statistical analysis of the network service information. The method may include identifying, by the device, a solution to the key question based on validating the hypothesis. The solution may identify a manner in which the network service management process is to be modified in order to improve the performance metric. The method may include forecasting, by the device, a network service demand based on the solution to the key question. The forecasted network service demand may identifying a quantity of future network service actions expected based on implementing the solution within the network service management process. The method may include performing, by the device, capacity planning based on the forecasted network service demand. A result of performing capacity planning may identify network service resources to satisfy the forecasted network service demand. The method may include scheduling, by the device, the network service resources such that the solution is implemented within the network service management process.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for receiving and storing network service information associated with a network service management process;

FIG. 5 is a diagram of an example implementation relating to the example process shown in FIG. 4;

FIG. 6 is a flow chart of an example process for performing network service analytics associated with a network service management process;

FIG. 7 is a flow chart of an example process for performing a root cause analysis associated with a key question; and

FIGS. 8A-8G are diagrams of an example implementation relating to the example processes shown in FIG. 6 and FIG. 7.

### DETAILED DESCRIPTION

The following detailed description of example implementations refers to the accompanying drawings. The same reference numbers in different drawings may identify the same or similar elements.

A network service provider may utilize a network service management process in order to resolve customer issues associated with network services (e.g., broadband services, landline services, etc.) provided by the network service provider. The network service management process may include a command center (e.g., including technical support, call screening/triage, general support for network service technicians in the field, network support for network service technicians in the field, final test desks, etc.) and a field force (e.g., field force offices, network service technicians, field force managers, etc.) in order to resolve customer issues. Optimization of such a process may be difficult since the network service management process may require scheduling and dispatching multiple field force technicians to different customer locations while minimizing cost and maintaining a high level of customer service. As such, the network service provider may desire a solution capable of driving network service resource optimization and improving overall customer experience when resolving customer issues using the network service management process.

Network service analytics is one such solution that may allow the network service provider to optimize, manage, improve, enhance, etc. the network service management process. Network service analytics may achieve this through reporting regarding network service performance metrics, root cause analysis of customer issues, forecasting network service demand, capacity planning of network service resources, and scheduling and dispatching the network service resources. In other words, network service analytics may allow a network service management process, associated with deploying technicians or other staff “into the field” to resolve customer issues, to be optimized. Moreover, network service analytics may provide a solution capable of driving (e.g., based on the use of network service performance information, quantitative analysis, explanatory models, predictive models, etc.) insightful decisions and actions in order to deliver beneficial business outcomes and a well managed field force.

Implementations described herein may provide a network services analytics solution that may allow a network service provider to optimize a network service management process through performance metric reporting, root cause analysis, network service demand forecasting, capacity planning, and scheduling and dispatching of network service resources.

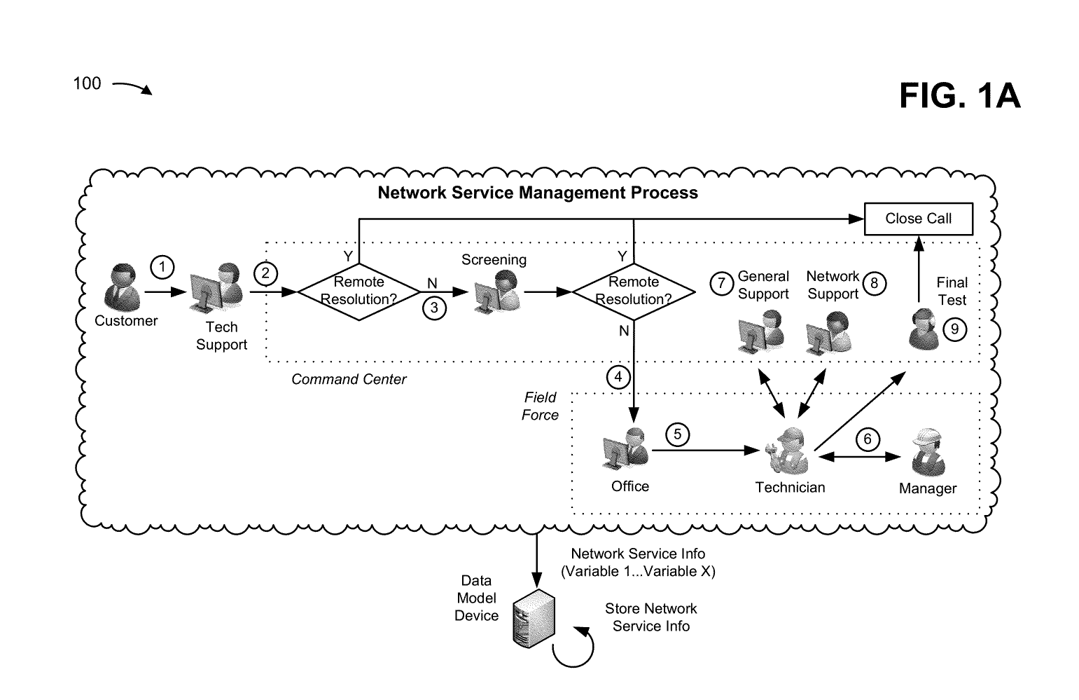

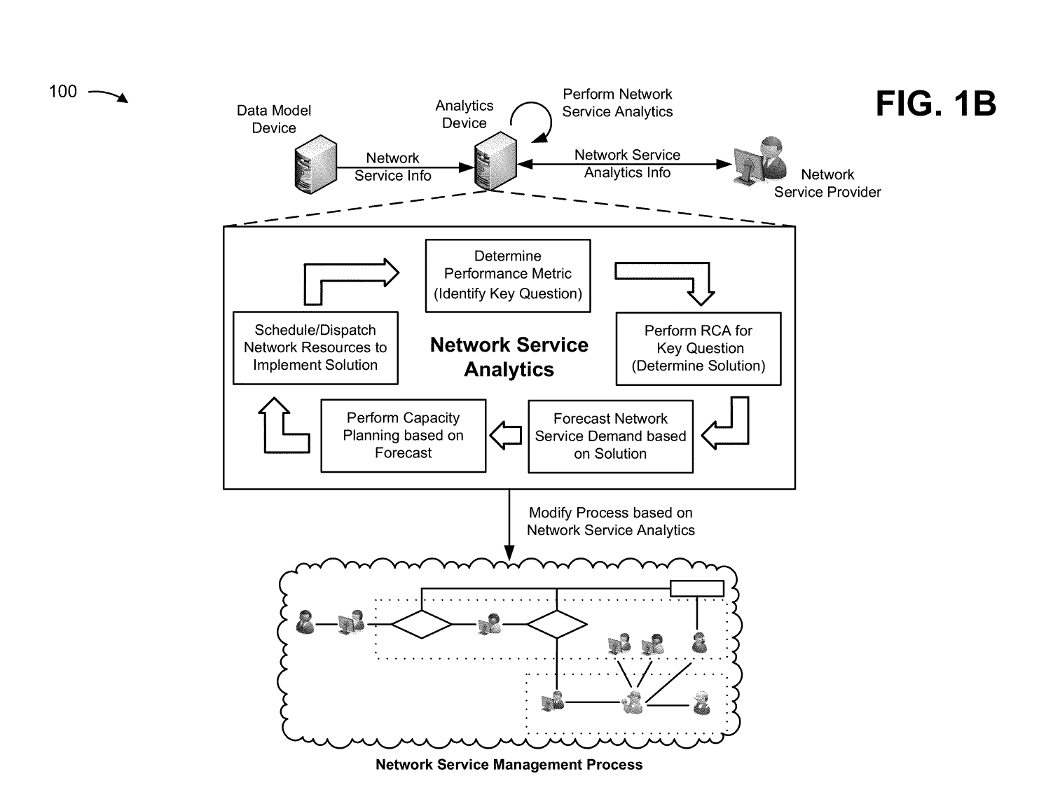

FIGS. 1A and 1B are diagrams of an overview of an example implementation 100 described herein. For the purposes of example implementation 100, assume that a network service provider (e.g., a telephone service provider, a wireless service provider, an Internet service provider, a television service provider, etc.) implements a multi-step network service process in order to resolve customer issues with services (e.g., broadband services, landline services, etc.) provided by the network service provider. Further, assume that the network service provider wishes to optimize the network service management process (e.g., to increase efficiency, to reduce operational costs, to increase customer satisfaction, etc.) by implementing a network service analytics solution.

As shown in FIG. 1A, a data model device, associated with the network service provider, may receive (e.g., from various components and/or devices associated with the network service management process) and store network service information associated with the network service management process. This network service information may include information associated with numerous aspects of the network service management process, and may serve as a basis for performing network service analytics.

As shown in FIG. 1B, an analytics device, associated with performing network service analytics, may receive the network service information from the data model device, and may perform network service analytics associated with the network service management process. As shown, the network service analytics may be performed as follows: (1) determining (e.g., based on the network service information) a performance metric, associated with the network service management process, and identifying a key question associated with improving the performance metric, (2) performing a root cause analysis, associated with the key question, to determine a potential solution to the key question, (3) forecasting a network service demand based on the solution, (4) performing capacity planning based on forecasting the network service demand, and (5) scheduling and dispatching network service resources, based on a result of capacity planning, in order to implement the solution within the network service management process.

As further shown, the network service management process may be modified based on performing the network service analytics (e.g., in order to improve, optimize, enhance, etc. the network service management process) and, as shown, the analytics device may continue to perform network service analytics in order to further optimize the network service management process.

In some implementations, as shown, the analytics device may provide, to a user (e.g., an administrator associated with the network service provider), a graphical and/or a textual representation associated with each component of the network service analytics to allow the user to modify, manage, monitor, view, update, interact with etc., results associated with performing the network service analytics.

In this way, a network service management process may be optimized using a network services analytics solution that includes performance metric reporting, root cause analysis, network service demand forecasting, capacity planning, and scheduling and dispatching of network service resources.

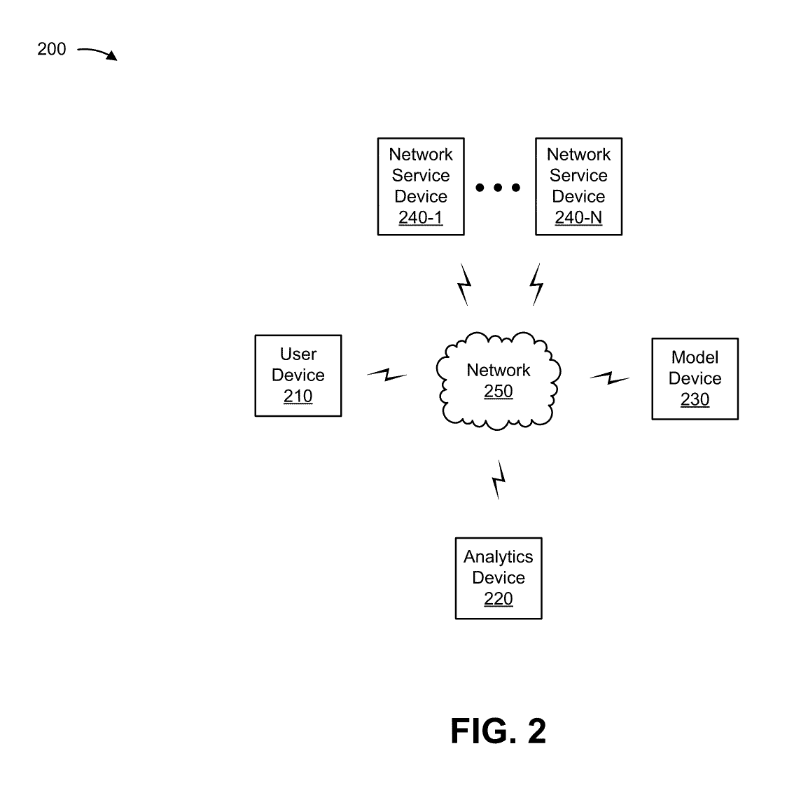

FIG. 2 is a diagram of an example environment 200 in which systems and/or methods, described herein, may be implemented. As shown in FIG. 2, environment 200 may include a user device 210, an analytics device 220, a model device 230, one or more network service devices 240-1 through 240-N (N≧1) (hereinafter referred to collectively as network service devices 240, and individually as network service device 240), and a network 250. Devices of environment 200 may interconnect via wired connections, wireless connections, or a combination of wired and wireless connections.

User device 210 may include a device capable of receiving, generating, storing, processing, and/or providing information associated with network service analytics that may be used to optimize a network service management process. For example, user device 210 may include a communications and/or computing device, such as a mobile phone (e.g., a smart phone, etc.), a laptop computer, a desktop computer, a tablet computer, a handheld computer, or a similar device. In some implementations, user device 210 may be capable of receiving (e.g., from analytics device 220) information associated with network service analytics (e.g., a performance metric report, information associated with a root cause analysis, a network service demand forecast, information associated with capacity planning, scheduling and/or dispatch information, etc.), and displaying (e.g., via a display screen associated with user device 210) the information associated with the network service analytics. Additionally, or alternatively, user device 210 may be capable of receiving (e.g., from a user) user input associated with performing the network service analytics. Additionally, or alternatively, user device 210 may receive information from and/or transmit information to another device in environment 200.

Analytics device 220 may include a device associated with performing network service analytics (e.g., generating a report, performing a root cause analysis, forecasting a network service demand, performing capacity planning, scheduling and/or dispatching network service resources, etc.) associated with a network service management process. For example, analytics device 220 may include a computing device, such as a server device. In some implementations, analytics device 220 may include one or more devices capable of receiving, providing, generating, storing, and/or processing network service information received from and/or provided by another device, such as user device 210 and/or model device 230. Additionally, or alternatively, analytics device 220 may be capable of performing network service analytics based on information (e.g., a statistical model, an algorithm, etc.) stored by analytics device 220.

Model device 230 may include a device associated with storing, managing, maintaining, etc. a data model associated with performing network service analytics for a network management process. For example, model device 230 may include a computing device, such as a server device. In some implementations, model device 230 may include one or more devices capable of receiving, storing, processing, and/or providing network service information associated with performing network service analytics. Additionally, or alternatively, model device 230 may be capable of sorting, formatting, preparing, storing and/or optimizing network service information (e.g., such that network service analytics may be performed by analytics device 220) based on a data model stored, maintained, managed, etc. by model device 230. Additionally, or alternatively, model device 230 may be capable of receiving (e.g., from network service devices 240) and storing network service information associated with a network service management process. Additionally, or alternatively, model device 230 may be capable of providing the network service information to another device, such as analytics device 220.

Network service device 240 may include a device involved in a network service management process. For example, network service device 240 may include a technical support device, a screening/triage device, a network support device, a general support device, a network service technician device, a field force office device, a final test device, and/or another type of device involved in the network service management process (e.g., a device implemented in the command center and/or used in the field to resolve a customer issue associated with a network service). In some implementations, network service device 240 may be capable of collecting network service information, associated with a network service variable, and providing the network service information to another device, such as model device 230 (e.g., such that network service analytics may be performed based on the network service information).

Network 250 may include one or more wired and/or wireless networks associated with a network service provider. For example, network 250 may include a cellular network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or another type of network.

The number and arrangement of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

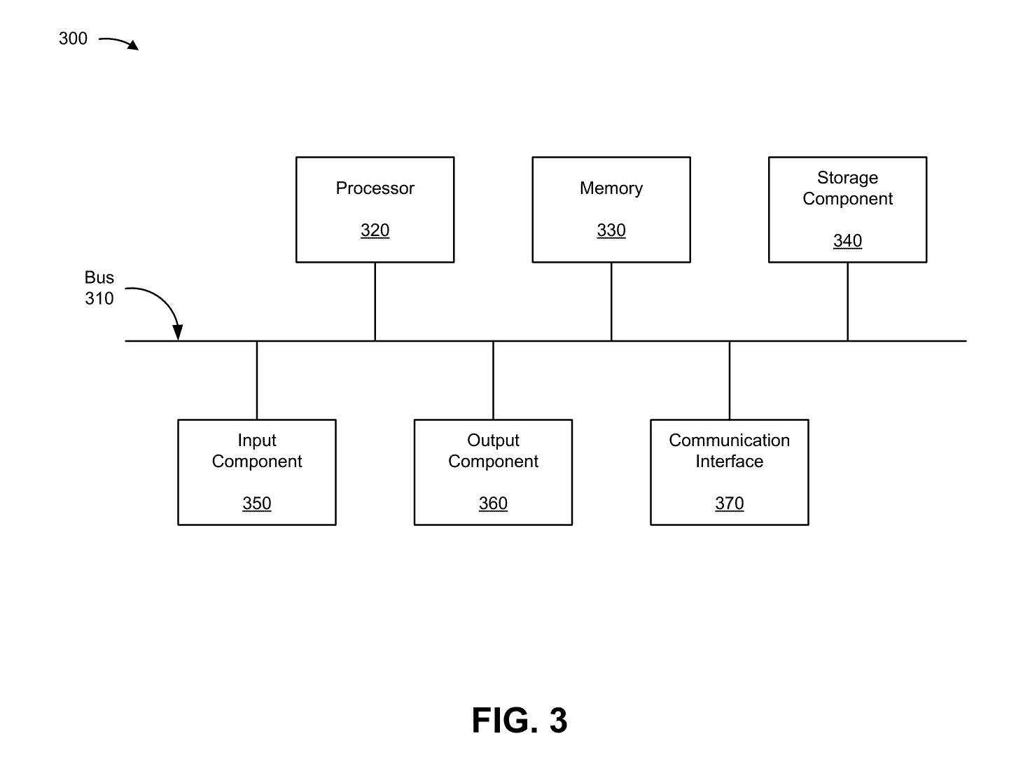

FIG. 3 is a diagram of example components of a device 300. Device 300 may correspond to user device 210, analytics device 220, model device 230, and/or network service device 240. In some implementations, user device 210, analytics device 220, model device 230, and/or network service device 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

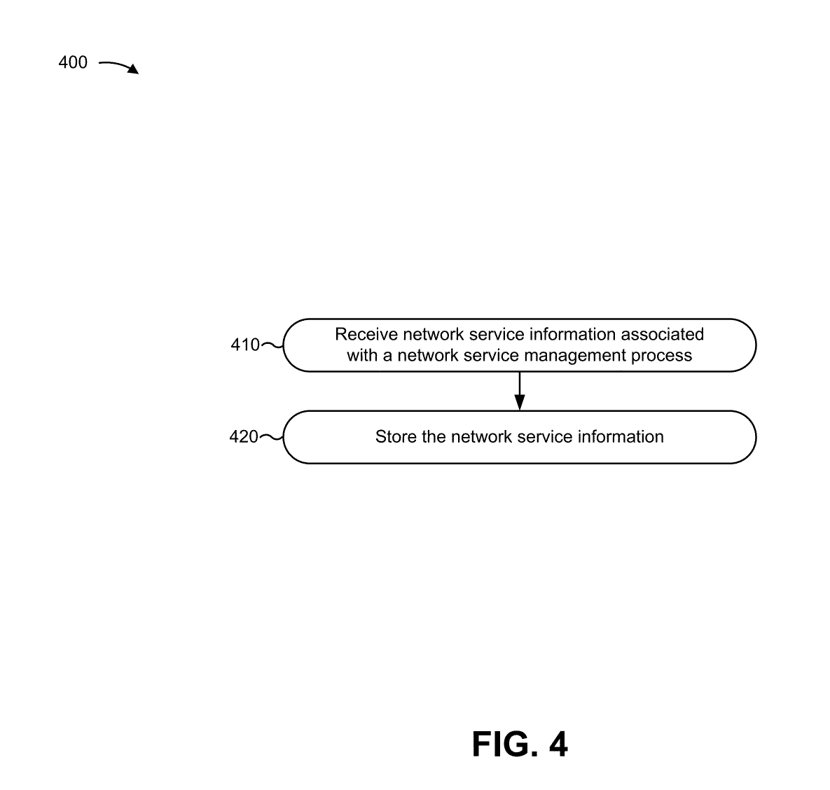

FIG. 4 is a flow chart of an example process 400 for receiving and storing network service information associated with a network service management process. In some implementations, one or more process blocks of FIG. 4 may be performed by model device 230. In some implementations, one or more process blocks of FIG. 4 may be performed by another device or a group of devices separate from or including model device 230, such as analytics device 220 and/or network service device 240.

As shown in FIG. 4, process 400 may include receiving network service information associated with a network service management process (block 410). For example, model device 230 may receive network service information associated with a network service management process. In some implementations, model device 230 may receive the network service information after network service device 240 provides the network service information.

Network service information may include information, associated with a network service management process, that may be used to determine a performance metric associated with the network service management process, and/or information that may be used to perform network service analytics associated with the network service management process.

In some implementations, the network service information may be associated with a variable associated with the network service management process. For example, assume that a network management process includes a number of steps, including an initial customer call step, a technical support step, a screening/triage step, a field force office step, a field force step, and a final test step (e.g., where a customer call may proceed through each step of the network service management process in order for a customer issue, associated with the customer call, to be resolved). In this example, the network service information for the initial customer call step may include network service information associated with the following variables: information associated with a business unit type associated with the customer (e.g., retail, business, corporate, etc.), call information associated with the initial customer call (e.g., a date, a start time, an end time, a telephone number, etc.), a location associated with the customer issue (e.g., a region, a state, a city, a street address, etc.), a tenure associated with the customer, a product type associated with the customer issue (e.g., a broadband product, a landline product, etc.), and/or another type of information. Here, the network service information for the technical support step may include network service information associated with the following variables: information associated with an operator that handles the initial customer call (e.g., an operator identification number, an operator name, a network service device 240 identifier associated with the operator, etc.), an issue type associated with the customer issue, a call duration for the initial customer call, and/or another type of information.

Continuing with this example, the network service information for the screening/triage step may include network service information associated with the following variables: information that identifies network service device 240 associated with the screening/triage step, a date that screening/triage was performed, information associated with screening/triage protocol adherence (e.g., whether a second line was used, whether electrical testing was conducted, whether negotiation techniques were used, whether a screening/triage script was followed, etc.), information associated with an action resulting from the screening/triage step (e.g., whether the customer issue was remotely resolved, whether the customer issue is to be resolved by the field force, whether the customer call was a bad call, etc.), information associated with a classification of the customer issue that is remotely resolved (e.g., recurrent, repeat, etc.). The network service information for the field force office step may include network service information associated with the following variables: information associated with attributes of a technician associated with resolving the customer issue (e.g., availability information, skill information, location information, contact information, etc.), customer information associated with the customer issue, information that identifies the customer issue, information that identifies network service device 240 associated with the field force office step, and/or another type of information.

Finishing with this example, the network service information for the field force step may include network service information associated with the following variables: information associated with a technician that attempts to resolve the customer issue (e.g., a technician identifier, a technician name, technician contact information, etc.), a type of action taken by the technician (e.g., an installation, an equipment change, a resettlement, a repair, troubleshooting, etc.), service level agreement information associated with resolving the customer issue, support information associated with resolving the customer issue (e.g., technical support received by the technician, general network support received by the technician, etc.), and/or another type of information. Finally, the network service information for the final test step may include network service information associated with the following variables: information indicating whether a final test was performed, information associated with adherence to a final test protocol, information associated with a final customer call (e.g., a start time, an end time, a phone number, etc.), information that identifies network service device 240 associated with the final customer call, customer feedback regarding the technician associated with resolving the customer issue, classification information associated with the customer issue, information associated with adherence to a final customer call protocol (e.g., whether a history of customer issues was checked, whether electrical testing was conducted, whether negotiation techniques were used, whether a final call script was followed, etc.), and/or another type of information.

In some implementations, model device 230 may receive the network service information from one or more network service devices 240 associated with the network management process. For example, a first network service device 240, associated with the initial customer call step (e.g., a technical support device used by an operator to receive the initial customer call), may collect first network service information, associated with the initial customer call, and may provide the first network service information to model device 230 (e.g., after the initial customer call ends). In this example, a second network service device 240, associated with a screening/triage step (e.g., a screening device used by a screening operator to attempt to remotely resolve the customer issue), may collect second network service information, associated with the screening/triage step, and may provide the second network service information to model device 230. In a similar manner, network service information associated with the entire network service management process (e.g., and for multiple customer issues and/or customer calls) may be collected and provided to model device 230.

In some implementations, the network service management process may include additional, fewer, or different steps than those described above. Additionally, or alternatively, the network service information may include additional, less, or different network service information than the examples of network service information described above.

As further shown in FIG. 4, process 400 may include storing the network service information (block 420). For example, model device 230 may store the network service information. In some implementations, model device 230 may store the network service information when model device 230 receives the network service information. Additionally, or alternatively, model device 230 may store the network service information based on information, indicating that model device 230 is to store the network service information, received from another device, such as network service device 240.

In some implementations, model device 230 may store the network service information in a memory location (e.g., a RAM, a ROM, a cache, a hard disk, etc.) of model device 230. Additionally, or alternatively, model device 230 may provide the network service information to another device for storage. In some implementations, model device 230 may store the network service information such that model device 230 may retrieve the network service information at a later time (e.g., in order to provide the network service information to analytics device 220).

In some implementations, model device 230 may store the network service information based on a data model stored, managed, maintained, etc. by model device 230. For example, in some implementations, model device 230 may store information associated with a data model used to sort, format, prepare, store, and/or optimize the network service information such that network service analytics may be performed based on the network service information, and model device 230 may store the network service information in accordance with the data model.

Additionally, or alternatively, model device 230 may store the network service information based on a category associated with the network service information. For example, model device 230 may be configured to sort, format, prepare, store, etc. the network service information based on one or more categories of network service information (e.g., where each category may include network service information associated with one or more variables), such as an end-to-end category (e.g., associated with performing network management service analytics associated with the overall network service management process), a customer service category, a command center category, a field force category, and/or a final test category.

In some implementations, the data model stored by model device 230 may be a unified data model that may be applied to network service management processes associated with different network service providers. In other words, the unified data model may be generalized such that the network service information, as defined by the unified data model, may be applied to multiple and/or different network service management processes, associated with different entities (e.g., different telecommunications entities, different field service entities, etc.), for the purpose of performing network service analytics.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

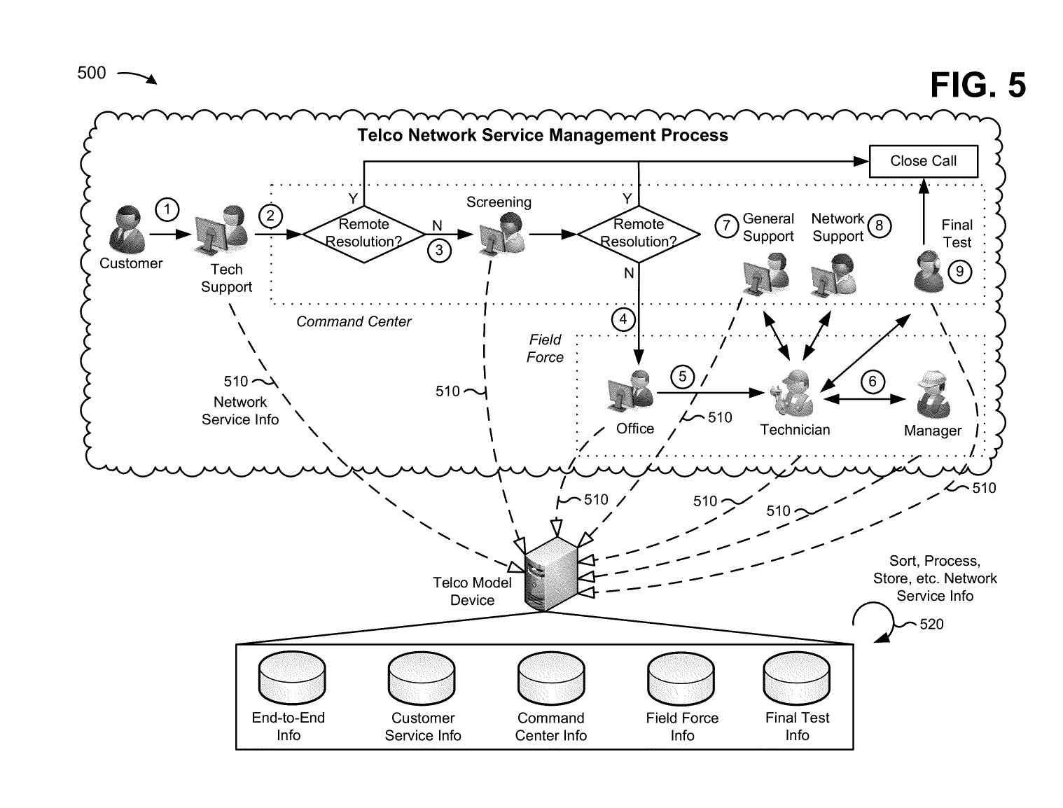

FIG. 5 is a diagram of an example implementation 500 relating to example process 400 shown in FIG. 4. FIG. 5 shows an example of receiving and storing network service information associated with a network service management process.

As shown in FIG. 5, a network service provider (e.g., Telco) may utilize a network service management process that includes a command center and a field force that provide network service management in the following manner: (1) receiving (e.g., by a technical support operator associated with the command center) a customer call regarding a customer issue associated with a network service, (2) attempting (e.g., by the technical support operator) to remotely resolve the customer issue (if the customer issue is remotely resolved then the customer call is closed), (3) if the customer issue is not resolved, screening (e.g., by a screening/triage operator associated with the command center) the customer call to determine a reason for non-resolution and to re-attempt to remotely resolve the customer issue (if the customer issue is remotely resolved then the customer call is closed), (4) if the customer issue is not resolved, forwarding (e.g., by the screening/triage operator) the customer issue to a field force office to identify an origin of the customer issue, manage issue resolution, and assign a network service technician (e.g., included in a field force) to resolve the customer issue, and (5) assigning (e.g., by the field force office) the customer issue to the designated network service technician to resolve the customer issue. As shown, the network service technician may be (6) managed by a field force manager associated with ensuring that various network service resources work toward resolution of the customer issue. As shown, the network service technician may also be supported by (7) a general support team (e.g., associated with the command center) for network services (e.g., support related to non-network aspects such as hardware, inventory, logistics, etc.), (8) a network support team (e.g., associated with the command center) for network services, and (9) a final test operator (e.g., associated with the command center) for performing a final test associated with resolving the customer issue. As further shown, after the customer issue is resolved by the network service technician, the network service management process may include the command center contacting the customer to capture customer feedback, a customer satisfaction level, etc. before closing the customer call.

For the purposes of FIG. 5, assume that model device 230 (e.g., Telco model device), associated with Telco, stores information associated with a data model designed to sort, format, prepare, store, and/or optimize network service information, associated with the Telco network service management process, to allow network service analytics to be performed in order to optimize the network service management process.

As shown in FIG. 5, and by reference number 510, various network service devices 240, associated with the Telco network service management process, may provide network service information (e.g., for multiple variables associated with each step of the network service management process) to the Telco model device. As shown, the Telco model device may receive the network service information associated with each step included in the network service management process.

As shown by reference number 520, the Telco model device may sort, format, process, store etc. the network service information (e.g., based on the multiple variables associated with the network service information) into a group of categories, associated with a Telco data model, that includes an end-to-end information category, a customer service information category, a command center information category, a field force information category, and a final test information category. In this way, the Telco model device may receive and store network service information, associated with multiple customer issues resolved via the Telco network service management process, from multiple network service devices 240 (e.g., associated with the steps of the network service management process). As described below, the network service information may then be used to perform network service analytics associated with the Telco network service management process.

As indicated above, FIG. 5 is provided merely as an example. Other examples are possible and may differ from what was described with regard to FIG. 5.

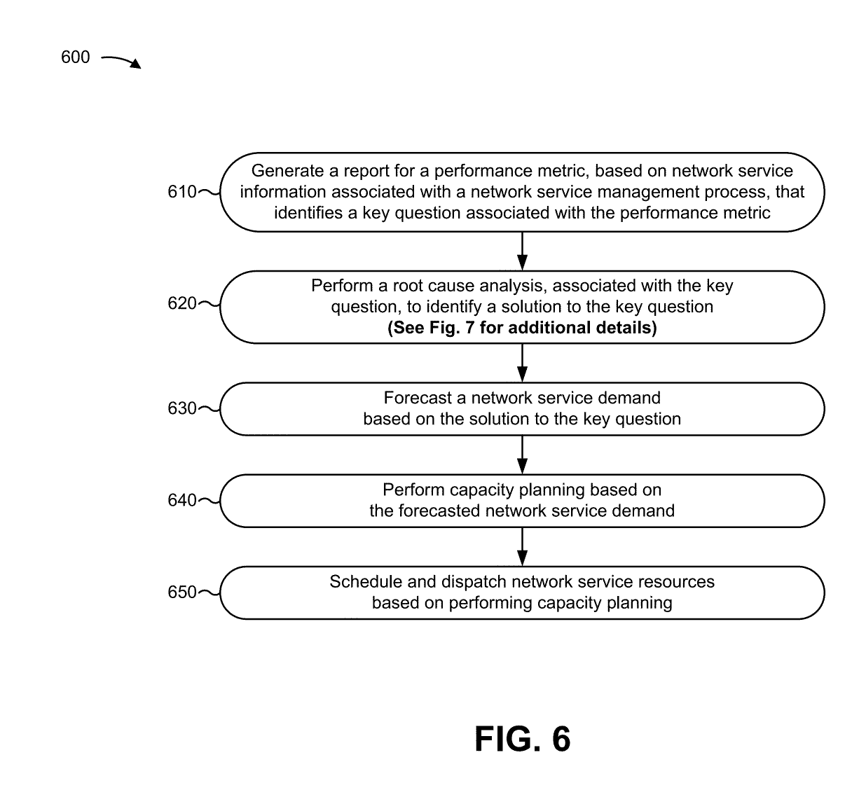

FIG. 6 is a flow chart of an example process 600 for performing network service analytics associated with a network service management process. In some implementations, one or more process blocks of FIG. 6 may be performed by analytics device 220. In some implementations, one or more process blocks of FIG. 6 may be performed by another device or a group of devices separate from or including analytics device 220, such as user device 210 and/or model device 230.

As shown in FIG. 6, process 600 may include generating a report for a performance metric, based on network service information associated with a network service management process, that identifies a key question associated with the performance metric (block 610). For example, analytics device 220 may generate a report for a performance metric, based on network service information associated with a network service management process, that identifies a key question associated with the performance metric. In some implementations, analytics device 220 may generate the report when analytics device 220 receives information indicating that analytics device 220 is to generate the report.

A performance metric may include a measurement, a value, etc., associated with a network service management process, that indicates a level of performance associated with an aspect of the network service management process. In some implementations, the performance metric may be an overall (e.g., end-to-end) performance metric (e.g., based on end-to-end network service information) that can be broken down into one or more sub-metrics (e.g., a customer service sub-metric, a command center sub-metric, a field force sub-metric, a final test sub-metric, etc.), where each sub-metric may be determined based on one or more categories of network service information, as illustrated in the example table below. Additionally, or alternatively, the performance metric may be associated with a particular dimension (e.g., speed, quality, efficiency, etc.) and issue type associated with a network service related to the performance metric (e.g., an installation, a repair, etc.). As an example, a group performance metrics associated with the network service management process may include:

| | Customer | Command | | | | |
|---|---|---|---|---|---|---|
| End-to-End | Service | Center | Field Force | Final Test | Dimension | Type |
| Average | Avg. Tech. | Avg. Triage | Avg. Repair | — | Speed | Repair |
| Repair Time | Support Time | Time | Time | | | |
| Average | Avg. Pending | Avg. Sched. | Avg. Install | — | Speed | Installation |
| Install Time | Order Time | Order Time | Time | | | |
| Cancellation | Pending Rate | Pending | Pending | — | Quality | Installation |
| Rate | | Rate | Rate | | | |
| Repeated | Originated @ | Originated | Originated | With/Without | Quality | Repair |
| Tickets | Tech. Support | @ Triage | @ Field | Certification | | |
| Repair within | — | — | — | With/Without | Quality | Installation |
| Waranty | | | | Certification | | |
| Repairs per | — | — | — | — | Quality | Repair |
| Client Base | | | | | | |
| Remote | RR @ Tech. | RR @ | — | — | Efficiency | Repair |
| Resolution | Support | Triage | | | | |
| Productivity | AHT, | Service | Visits per | — | Efficiency | Both |
| | Scheduling Rate | Levels, AHT | Ticket | | | |

For example, as shown in the above example table, an end-to-end performance metric may include an average repair time (e.g., associated with a speed dimension of a repair) that can be broken down into three sub-metrics, including an average technical support time associated with a customer service portion of the network service management process, an average screening/triage time associated with a command center portion of the network service management process, and an average repair time associated with a field force portion of the network service management process. Other end-to-end performance metrics included in the table may be broken down in a similar manner.

In some implementations, analytics device 220 may generate a report associated with the performance metric. For example, analytics device 220 may determine (e.g., based on network service performance information stored by model device 230) a performance metric (e.g., an end-to-end metric, a sub-metric, etc.), and analytics device 220 may provide the report to user device 210 (e.g., such that a user of user device 210 may view the report). In some implementations, analytics device 220 may store information that identifies a group of performance metrics for which analytics device 220 may generate a report (e.g., when analytics device 220 hosts a network service analytics application configured with a group of defined performance metrics).

In some implementations, analytics device 220 may generate the report based on user input. For example, assume that user device 210 allows a user to access a network service analytics application (e.g., hosted by analytics device 220). In this example, user device 210 may receive user input indicating that analytics device 220 is to generate the report for a particular performance metric, and analytics device 220 may generate (e.g., based on network service information stored by model device 230) the report for the particular performance metric, and may provide the report to user device 210 (e.g., and the user may view the report).

In some implementations, the report may include a graphical and/or a textual representation of the performance metric (e.g., a line graph, a bar graph, a map, a chart, a table, etc.). Additionally, or alternatively, the report may include information associated with an end-to-end performance metric and information associated with sub-metrics of the end-to-end performance metric (e.g., such that the user may view information associated with the end-to-end metric as well as information associated with the sub-metrics of the end-to-end metric). Additionally, or alternatively, the report may include information indicating whether the performance metric is above or below a threshold value (e.g., whether the performance metric is greater than or equal to a target value, whether the performance metric is less than a target value, etc.).

In some implementations, the report may be associated with a geographic location related to the performance metric. For example, analytics device 220 may generate a report for the performance metric for the network service management process as related to a state, a region, a city, a command center, etc. Additionally, or alternatively, the report may be based on a product associated with the network service provider. For example, analytics device 220 may generate a report for the performance metric as related to a broadband product, a landline product, etc. associated with the network service provider (e.g., and managed via the network service management process).

In some implementations, analytics device 220 may generate a report that includes a summary associated with multiple performance metrics. For example, analytics device 220 may generate a report that includes a performance metric summary that intends to capture trends across multiple performance metrics such that the user may view an indication of performance associated with each of the multiple performance metrics (e.g., in a single report). In some implementations, the summary may indicate whether each of the multiple performance metrics is performing above or below a particular threshold.

In some implementations, analytics device 220 may generate a report that identifies a key question associated with the performance metric. A key question, associated with a performance metric, may include a business issue, associated with the network management process, that may affect the performance metric. For example, for a performance metric indicating an average end-to-end repair time, a key question may include “how to increase the repair speed?” In some implementations, analytics device 220 may store information that identifies one or more key questions associated with each performance metric. For example, analytics device 220 may host a network service analytics application that is configured with one or more key questions that correspond to one or more performance metrics. Continuing the above example, if analytics device 220 generates a report associated with the average end-to-end repair time performance metric, then analytics device 220 may generate a report that includes information identifying the “how to increase the repair speed?” key question. Here, the user may view the report, and may select (e.g., via user device 210) the key question in order to perform further network service analytics associated with the key question.

In this way, analytics device 220 may generate (e.g., based on network service information associated with a network management process) a report that includes information associated with a performance metric and that identifies one or more key questions associated with the performance metric. Further network service analytics may then be performed, as described below.

As further shown in FIG. 6, process 600 may include performing a root cause analysis, associated with the key question, to identify a solution to the key question (block 620). For example, analytics device 220 may perform a root cause analysis, associated with the key question, to identify a solution to the key question. In some implementations, analytics device 220 may perform the root cause analysis after analytics device 220 generates the report for the performance metric. Additionally, or alternatively, analytics device 220 may perform the root cause analysis after analytics device 220 identifies the key question associated with the performance metric. Additionally, or alternatively, analytics device 220 may perform the root cause analysis when analytics device 220 receives information (e.g., user input) indicating that analytics device 220 is to perform the root cause analysis.

A root cause analysis may include identifying (e.g., based on an issue tree associated with the key question) a hypothesis associated with the key question, validating (or invalidating) the hypothesis based on network service information, associated with the key question, to determine a solution to the key question, and performing a simulation associated with the solution to the key question. A solution to the key question may identify a manner in which the network service management process may be modified in order to improve the performance metric associated with the key question. For example, if a key question is “how to increase remote resolution of customer issues,” then a hypothesis may include: “greater adherence to a remote resolution protocol will increase remote resolution.” In this example, analytics device 220 may validate (e.g., based on network service information stored by model device 230) the hypothesis, to determine a solution to the key question, and may perform a simulation, associated with the solution to determine how much adherence to the remote resolution protocol should be increased in order to optimally increase the rate at which customer issues are remotely resolved. In some implementations, the simulation may include consideration of a financial impact associated with the solution.

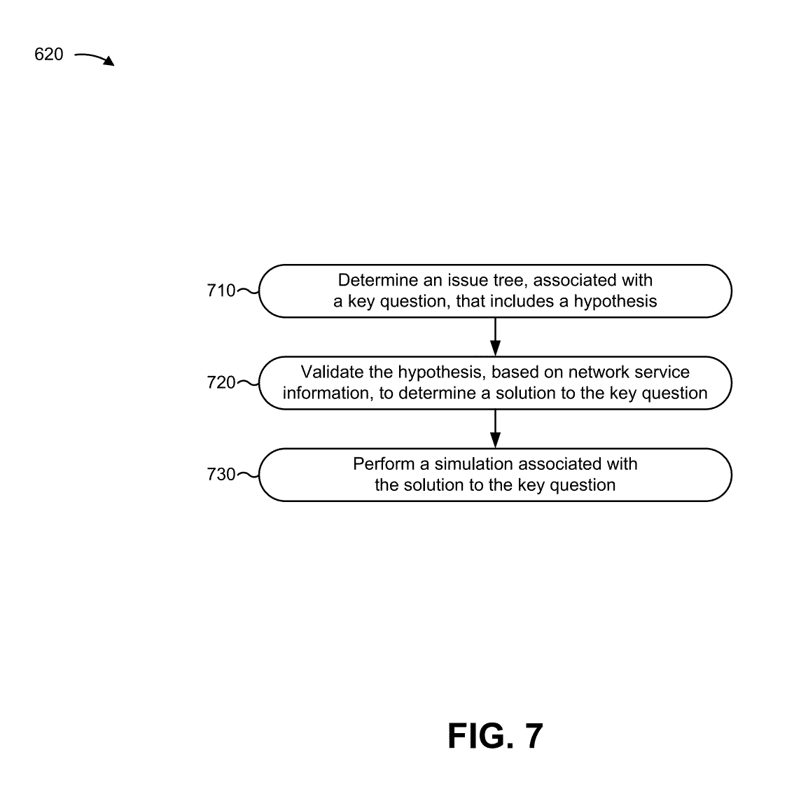

Additional details associated with performing a root cause analysis to determine a solution to a key question are discussed below with regard to FIG. 7.

As further shown in FIG. 6, process 600 may include forecasting a network service demand based on the solution to the key question (block 630). For example, analytics device 220 may forecast a network service demand based on the solution to the key question. In some implementations, analytics device 220 may forecast the network service demand after analytics device 220 performs the root cause analysis to determine the solution to the question. Additionally, or alternatively, analytics device 220 may forecast the network service demand when analytics device 220 receives (e.g., based on user input) an indication that analytics device 220 is to forecast the network service demand.

A forecasted network service demand may include a projected quantity of network service actions (e.g., to be supported by the network service provider) associated with a network service management process. For example, the forecasted network demand may include a network service demand associated with a quantity of expected customer calls, a quantity of expected service orders associated with customer issues to be resolved by a field force, a quantity of expected installations, a quantity of expected cancellations, a quantity of expected repairs, a quantity of calls expected from network service technicians in the field, etc.

In some implementations, analytics device 220 may forecast the network service demand based on the solution to the key question. For example, analytics device 220 may identify a solution to the key question (e.g., increasing adherence to a remote resolution protocol by 5% to increase a likelihood of remote resolution of customer issues), and may forecast a network service demand (e.g., an expected quantity of additional operators required based on increasing the adherence by 5%, an expected quantity of technicians required based on an increase to the likelihood of remote resolution, etc.) based on the solution to the key question. In other words, analytics device 220 may forecast a network service demand based on modifications, associated with the solution, that may be implemented within the network service management process.

Additionally, or alternatively, analytics device 220 may forecast the network service demand based on historical network service information associated with the network service management process. For example, analytics device 220 may forecast a quantity of expected customer calls based on historical network service information that identifies a quantity of customer calls received at an earlier time (e.g., a previous four month period, a previous one year period, etc.). Additionally, or alternatively, analytics device 220 may forecast the network service demand based on external information, such as a weather forecast. In some implementations, analytics device 220 may forecast a network service demand for a particular time period (e.g., 15 days, 12 months, etc.).

In some implementations, analytics device 220 may forecast the network service demand associated with a particular network service product (e.g., a broadband product, a landline product, etc.). Additionally, or alternatively, analytics device 220 may forecast the network service demand associated with a particular geographic location (e.g., a region, a state, a county, a city, a command center, etc.).

In some implementations, analytics device 220 may forecast the network service demand based on a group of forecast models. For example, analytics device 220 may store information associated with a group of forecast models (e.g., ten forecast models, fifteen forecast models, etc.). In this example, analytics device 220 may determine (e.g., based on the network service information available to analytics device 220) a best-fit forecast model of the group of forecast models, and may forecast the network service demand using the best-fit forecast model.

In some implementations, analytics device 220 may provide the network service demand forecast such that the user may view (e.g., via user device 210) the forecasted network service demand. In some implementations, the network service demand forecast may include a graphical and/or a textual representation of the network service demand forecast (e.g., a line graph, a bar graph, a map, a chart, a table, etc.). In some implementations, analytics device 220 may (e.g., automatically) forecast the network service demand on a periodic basis (e.g., daily, weekly, etc.) and may provide the forecasted network service demand such that the user may view the forecasted network service demand (e.g., via user device 210). Additionally, or alternatively, analytics device 220 may update the forecasted network service demand (e.g., when analytics device 220 receives additional network service information associated with the forecast).

As further shown in FIG. 6, process 600 may include performing capacity planning based on the forecasted network service demand (block 640). For example, analytics device 220 may perform capacity planning based on the forecasted network service demand. In some implementations, analytics device 220 may perform capacity planning after analytics device 220 forecasts the network service demand. Additionally, or alternatively, analytics device 220 may perform capacity planning when analytics device 220 receives (e.g., based on user input, based on a configuration of analytics device 220, etc.) an indication that analytics device 220 is to perform capacity planning based on the forecasted network service demand.

When performing capacity planning, analytics device 220 may determine a quantity of network service resources (e.g., network service technicians, technical support operators, screening operators, final test operators, etc.) required to satisfy a forecasted network service demand (e.g., a quantity of expected repairs, a quantity of expected customer calls, etc.). In some implementations, analytics device 220 may perform capacity planning based on the forecasted network service demand. For example, analytics device 220 may forecast a network service demand, and may use the forecasted network service demand as an input to a capacity planning model (e.g., stored by analytics device 220). In this example, analytics device 220 may receive, as output from the capacity planning model, information that identifies an estimated quantity of network service resources (e.g., a quantity of network service technicians, a quantity of technical support operators, a quantity of screening operators, a quantity of final test operators, etc.) that may be required to meet the forecasted network service demand.

In some implementations, analytics device 220 may perform capacity planning for a particular period of time (e.g., 15 days, one month, one year, etc.). Additionally, or alternatively, analytics device 220 may perform capacity planning for a particular geographic location (e.g., a region, a state, a county, a city, a command center, etc.). Additionally, or alternatively, analytics device 220 may perform capacity planning associated with a skill level of network service technicians. For example, analytics device 220 may perform capacity planning to determine a quantity of single skilled network service technicians that may be required to meet the network service demand and/or a quantity of multi-skilled network service technicians that may be required to meet the network service demand.

In some implementations, analytics device 220 may provide a result of performing capacity planning such that the user may view (e.g., via user device 210) the result of performing capacity planning. For example, analytics device 220 may provide a graphical and/or a textual representation of capacity planning (e.g., a line graph, a bar graph, a map, a chart, a table, etc.). Additionally, or alternatively, analytics device 220 may update the result of performing capacity planning (e.g., when analytics device 220 updates the forecasted network service demand).

As further shown in FIG. 6, process 600 may include scheduling and dispatching network service resources based on performing capacity planning (block 650). For example, analytics device 220 may schedule and dispatch network service resources based on performing capacity planning. In some implementations, analytics device 220 may schedule and dispatch the network service resources after analytics device 220 performs capacity planning based on the forecasted network service demand. Additionally, or alternatively, analytics device 220 may schedule the network service resources when analytics device 220 receives (e.g., based on user input) an indication that analytics device 220 is to schedule and dispatch the network service resources.

When scheduling and dispatching network service resources, analytics device 220 may allocate, assign, manage, etc. a group of network service resources (e.g., network service technicians, technical support operators, screening operators, etc.) such that the network service management process implements the solution associated with the capacity plan (e.g., in order to optimize the network service management process to resolve customer issues associated with the solution). In some implementations, analytics device 220 may schedule and dispatch network service resources based on a result of performing capacity planning and/or based on a forecasted network service demand.

In some implementations, scheduling and dispatching may include one or more elements, such as service order quota management, management of one or more groups of network service resources (e.g., command center operators, network service technicians, etc.), customer appointment booking, routing of network service resources, dispatching service orders to network service technicians, monitoring and/or managing daily actions of network service resources, and/or another element. In some implementations, analytics device 220 may schedule and dispatch network service resources on a periodic basis (e.g., daily, weekly, etc.).

In some implementations, analytics device 220 may provide information associated with scheduling and dispatching the network service resources such that the user may view (e.g., via user device 210) the information associated with scheduling and dispatching the network service resources. For example, analytics device 220 may provide a graphical and/or a textual representation of a result of scheduling and dispatching the network service resources (e.g., a line graph, a bar graph, a map, a chart, table, etc.). Additionally, or alternatively, analytics device 220 update the result of scheduling and dispatching of network service resources (e.g., periodically during a given day).

The network service analytics solution described above may be repeated (e.g., after modifying the network service management process and collecting additional network service information) to further optimize the network service management process. In this way, a network service provider may be provided with a single network services analytics solution that allows the network service provider to optimize a network service management process through performance metric reporting, root cause analysis, network service demand forecasting, capacity planning, and scheduling and dispatching of network service resources.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a flow chart of an example process 700 for performing a root cause analysis associated with a key question. In some implementations, one or more process blocks of FIG. 7 may be performed by analytics device 220. In some implementations, one or more process blocks of FIG. 7 may be performed by another device or a group of devices separate from or including analytics device 220, such as user device 210, model device 230, and/or network service device 240.

As described above, in some implementations, analytics device 220 may perform the root cause analysis after analytics device 220 generates a report for a performance metric, after analytics device 220 identifies a key question associated with the performance metric, and/or when analytics device 220 receives information (e.g., user input) indicating that analytics device 220 is to perform the root cause analysis.

As shown in FIG. 7, process 700 may include determining an issue tree, associated with a key question, that includes a hypothesis (block 710). For example, analytics device 220 may determine an issue tree, associated with a key question, that includes a hypothesis. In some implementations, analytics device 220 may determine the issue tree after analytics device 220 identifies the key question associated with the performance metric, as described above. Additionally, or alternatively, analytics device 220 may determine the issue tree when analytics 220 device receives information (e.g., user input), indicating that analytics device 220 is to determine the issue tree.

An issue tree may include a set of queries, associated with a network service management process, that identifies one or more potential root causes associated with an under-achieving performance metric. The set of queries may lead to one or more hypotheses (e.g., each corresponding to the one or more potential root causes) associated with determining a solution to the key question. In some implementations, the issue tree may include multiple query levels and/or multiple query sub-levels associated with the key question. Additionally, or alternatively, the issue tree may include multiple hypotheses associated with the key question.

In some implementations, analytics device 220 may determine the issue tree based on information stored by analytics device 220. For example, analytics device 220 may store information that identifies an issue tree associated with a key question that may result from a report (e.g., associated with a performance metric) generated by analytics device 220, and analytics device 220 may determine the issue tree based on identifying the key question in the report. In other words, analytics device 220 may be determine the issue tree based on the key question (e.g., when the user selects the key question, included in the report, for root cause analysis). In some implementations, the issue tree may include multiple hypotheses. In some implementations, analytics device 220 may provide, for display to the user, the issue tree, and analytics device 220 may identify (e.g., based on user input) a particular hypothesis for further root cause analysis (e.g., validation, simulation, etc.), as described below.

As further shown in FIG. 7, process 700 may include validating the hypothesis, based on network service information, to determine a solution to the key question (block 720). For example, analytics device 220 may validate the hypothesis, based on network service information stored by model device 230, to determine a solution to the key question. In some implementations, analytics device 220 may validate the hypothesis after analytics device 220 determines the issue tree. Additionally, or alternatively, analytics device 220 may validate the hypothesis when the user selects the hypothesis, included in the issue tree, for validation. Additionally, or alternatively, analytics device 220 may validate the hypothesis when analytics device 220 receives (e.g., from another device) information indicating that analytics device 220 is to validate the hypothesis.

In some implementations, analytics device 220 may validate the hypothesis based on performing a statistical analysis associated with the hypothesis. For example, assume that analytics device 220 identifies a hypothesis, included in an issue tree, for validation. Analytics device 220 may receive (e.g., from model device 230) network service information associated with the hypothesis included in the issue tree. Analytics device 220 may then identify (e.g., based on the network service information) two or more variables (e.g., associated with the performance metric related to the hypothesis) that analytics device 220 may use to validate the hypothesis. In this example, analytics device 220 may validate the hypothesis by determining whether a relationship between the two or more variables can be identified in the network service performance information (e.g., by performing a statistical analysis, such as a correlation determination, a regression analysis, etc.). Here, analytics device 220 may validate the hypothesis if analytics device 220 determines that a relationship between the two or more variables may be identified in the network service information. Alternatively, analytics device 220 may invalidate the hypothesis if analytics device 220 determines that a relationship between the two more variables may not be identified in the network service information (e.g., analytics device 220 may then provide an indication that the hypothesis may not be validated, and may identify another hypothesis, associated with the key question, for validation, in the manner described above).

In some implementations, analytics device 220 may determine a solution, associated with the key question, based on validating the hypothesis. For example, assume that the key question “how to increase remote resolution of customer issues,” and that the hypothesis is that a command center (e.g., technical support operators, screening/triage operators) with lower adherence to a remote resolution protocol have a lower likelihood of remote resolution of customer issues. Here, if analytics device 220 validates the hypothesis (e.g., based on network service information associated with adherence to the remote resolution protocol, remote resolution rates, etc.), then analytics device 220 may determine a solution indicating that increasing adherence to the remote resolution protocol may increase the remote resolution rate. In some implementations, analytics device 220 may determine one or more solutions based on validating the hypothesis.

In some implementations, analytics device 220 may validate (or invalidate) the hypothesis based on user input. For example, analytics device 220 may provide, for display, the issue tree associated with the key question, and the user may select (e.g., via user device 210) a particular hypothesis for validation. Additionally, or alternatively, analytics device 220 may validate (or invalidate) multiple hypotheses in order to determine multiple solutions to a key question. In this way, analytics device 220 may determine one or more solutions, associated with the key question, that, if implemented within the network service management process, may go toward optimizing the network service management process.

As further shown in FIG. 7, process 700 may include performing a simulation, associated with the solution to the key question (block 730). For example, analytics device 220 may perform a simulation associated with the solution to the key question. In some implementations, analytics device 220 may perform the simulation after analytics device 220 determines the solution to the key question. Additionally, or alternatively, analytics device 220 may perform the simulation after analytics device 220 validates the hypothesis that leads to the solution. Additionally, or alternatively, analytics device 220 may perform the simulation when analytics device 220 receives (e.g., based on user input, based on a configuration of analytics device 220) information indicating that analytics device 220 is to perform the simulation.

In some implementations, analytics device 220 may perform the simulation by conducting additional statistical analyses to further investigate the solution. For example, analytics device 220 may perform a statistical analysis to determine an effect that modifying a first variable (e.g., increasing adherence to the remote resolution protocol), associated with the solution, may have on a second variable (e.g., increasing the remote resolution rate), associated with the solution, under different scenarios associated with modifying the first variable (e.g., determining how remote resolution rates may be improved by increasing adherence to the remote resolution protocol by 5%, determining how remote resolution rates may be improved by increasing adherence to the remote resolution process to 80%, etc.).

Additionally, or alternatively, analytics device 220 may perform the simulation by conducting a break-even analysis associated with the valid hypothesis. A break-even analysis may include an analysis that identifies a point at which a cost (e.g., in network service resources) of modifying first network variable (e.g., a quantity of additional operators required to achieve 80% adherence to the remote resolution protocol) and a cost of modifying a second network variable (e.g., a quantity of additional network service technicians required as a result of being unable to remotely resolve a particular percentage of customer issues) are minimized.

Additionally, or alternatively, analytics device 220 may perform the simulation by determining a financial impact associated with the solution. For example, analytics device 220 may receive (e.g., from model device 230, from network service device 240, etc.) financial information associated with modifying variables associated with the solution (e.g., a first variable and a second variable), and analytics device 220 may determine a financial impact that may occur due to a modification of the first variable and/or the second variable.

In some implementations, analytics device 220 may provide a result of performing the simulation such that the user may view (e.g., via user device 210) the result of performing the simulation. For example, analytics device 220 may provide a graphical and/or a textual representation of the result the simulation (e.g., a line graph, a bar graph, a map, a chart, a table, etc.). Additionally, or alternatively, analytics device 220 may (e.g., dynamically) update the result of the simulation (e.g., when the user interacts with the graphical representation associated with the simulation by modifying variables associated with the simulation).

In some implementations, analytics device 220 may perform multiple simulations associated with multiple solutions associated with a key question. For example, analytics device 220 may validate multiple hypotheses, associated with a key question, and may determine multiple solutions corresponding to the multiple hypotheses (e.g., in the manner described above). In this example, analytics device 220 may perform a simulation for each of the multiple solutions (e.g., including a regression analysis, a break even analysis, a financial impact determination, etc.). Analytics device 220 may then compare results of the simulations (e.g., based on financial impact, based on a degree of modification to the network service management process, etc.), may rank the solutions accordingly, and may provide information associated with the solution comparison and/or solution ranking for display to the user. In this way, the user may be provided with multiple solutions, associated with the key question, along with multiple simulations associated with implementing the multiple solutions (e.g., including a financial impact associated with each solution).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

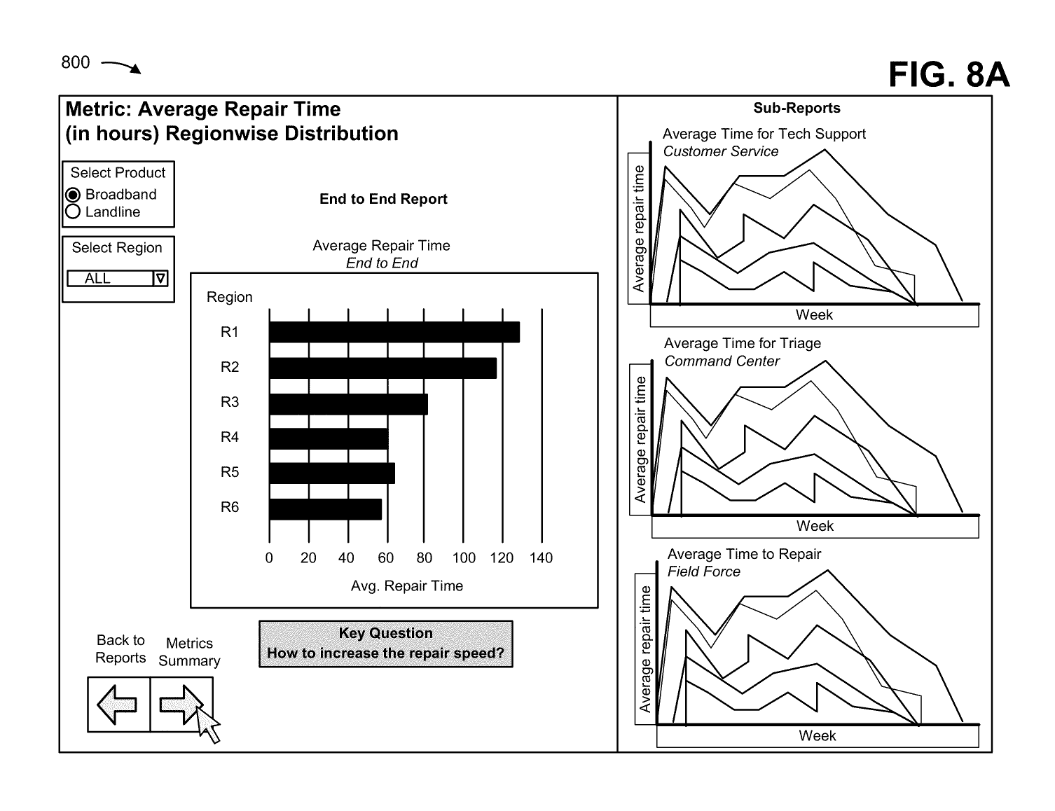

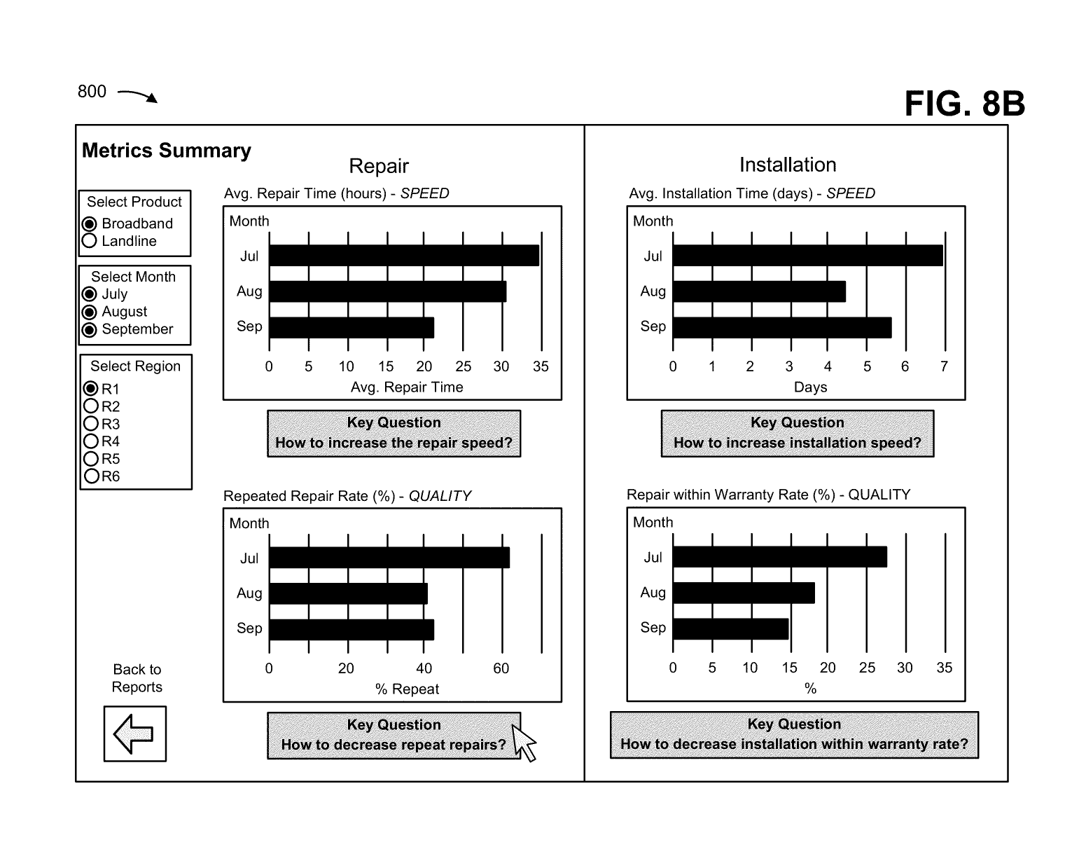

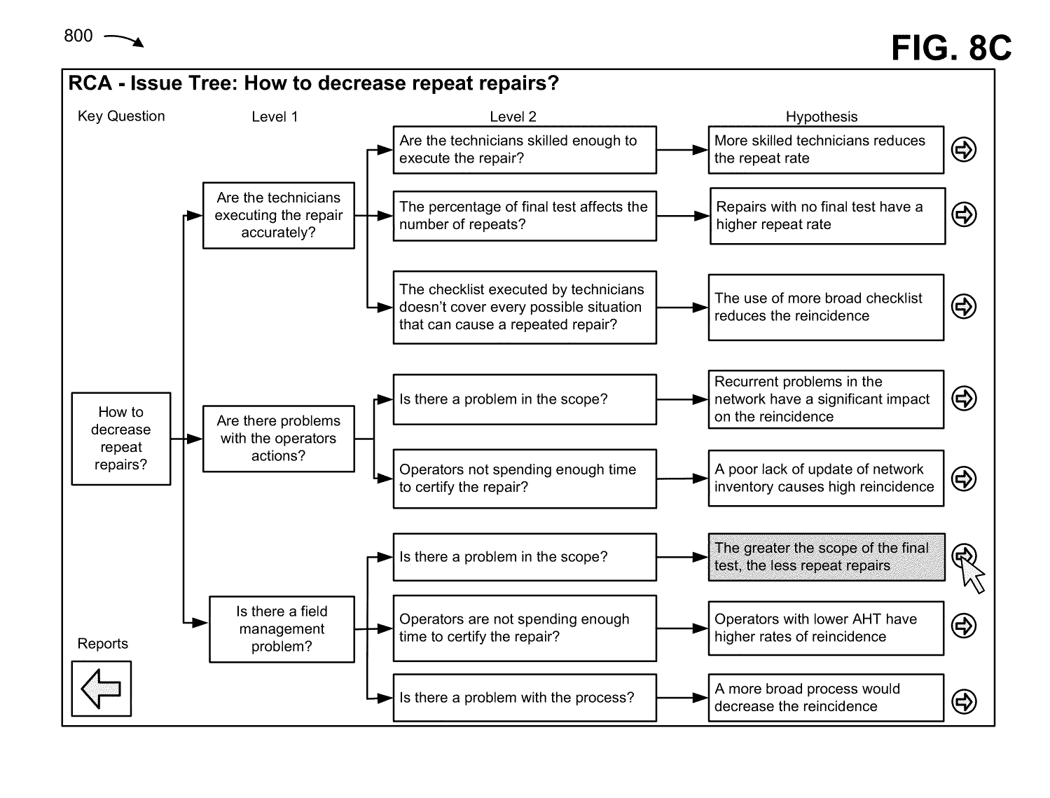

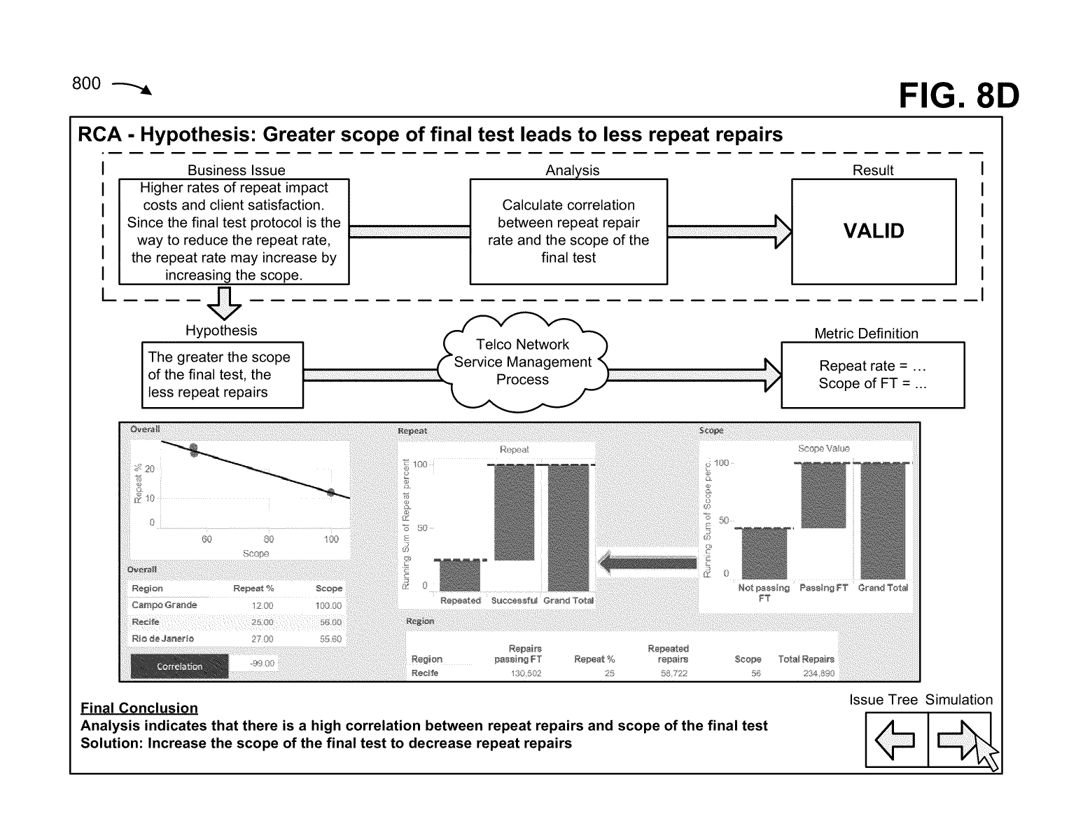

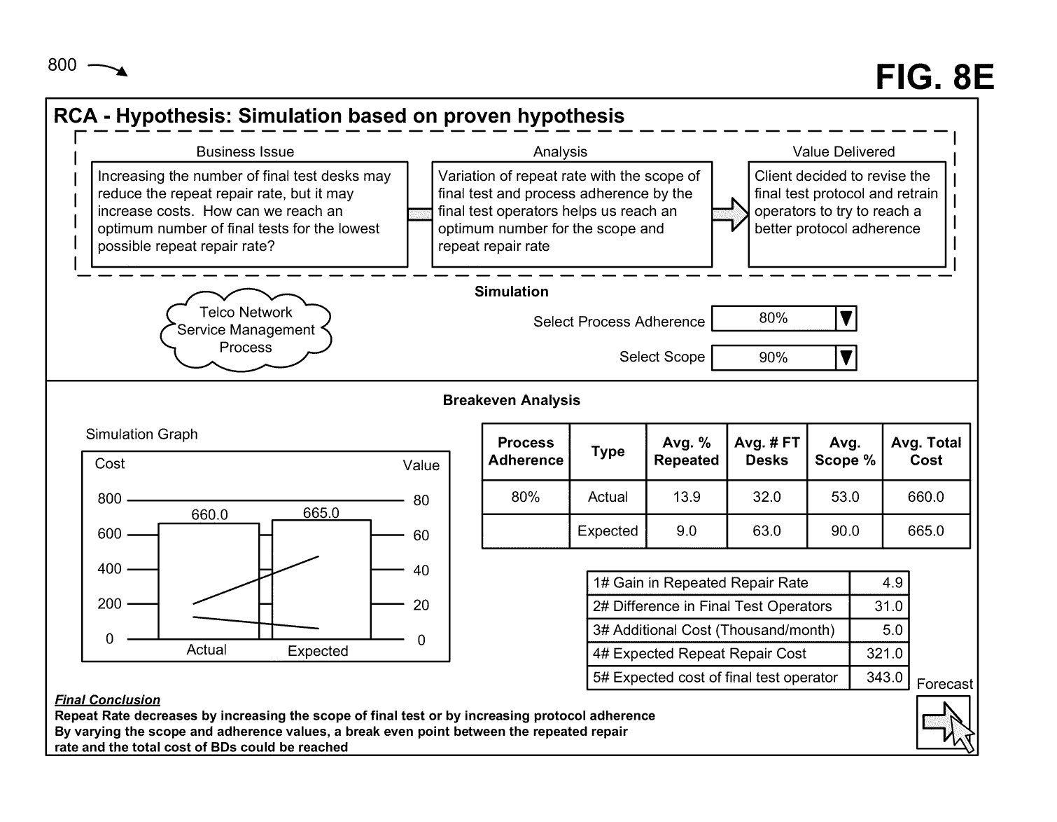

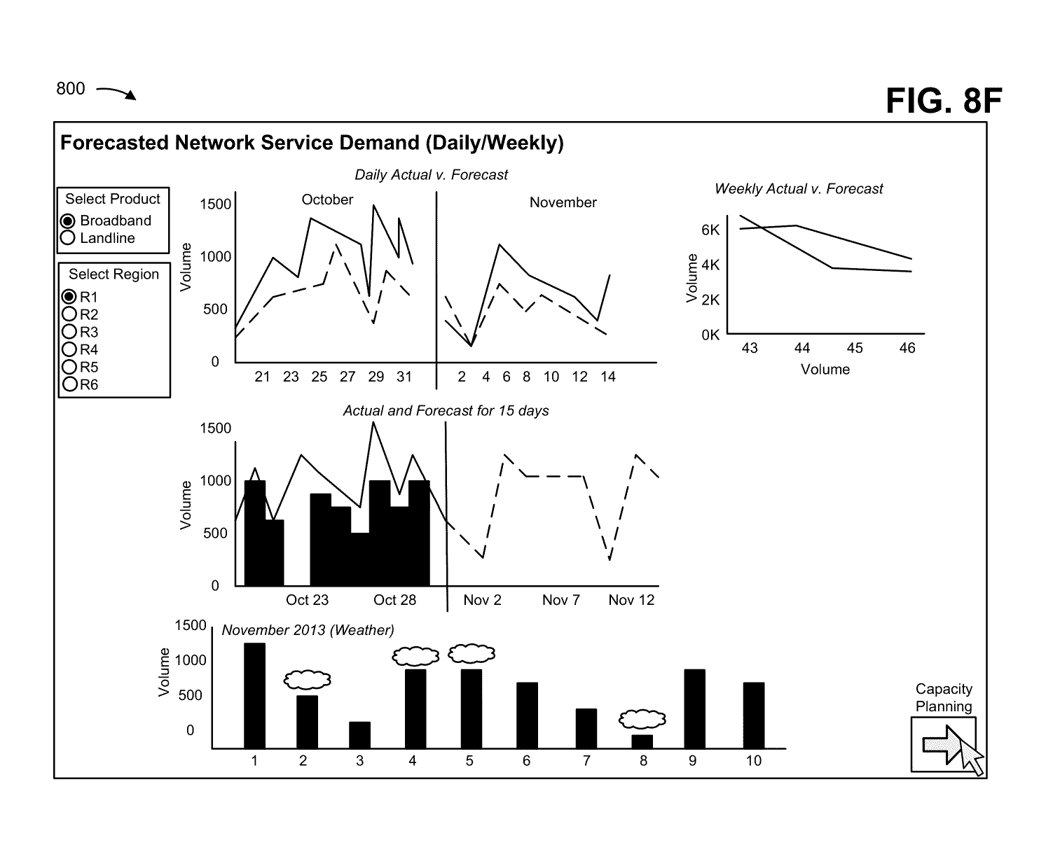

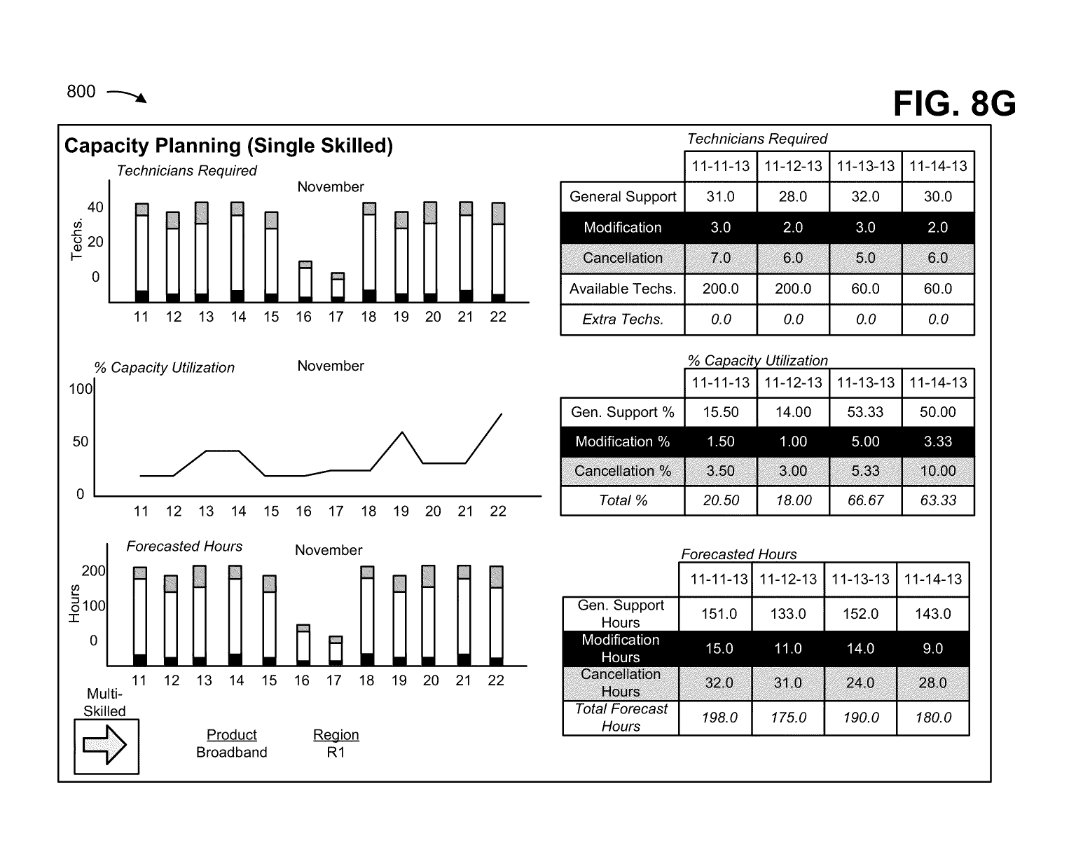

FIGS. 8A-8G are diagrams of an example implementation 800 relating to example processes 600 and 700 shown in FIG. 6 and FIG. 7, respectively. For the purposes of example implementation 800, assume that a network service provider (e.g., Telco) implements a network service management process (e.g., as described above with regard to FIG. 5), and that Telco wishes to optimize the network service management process using a network service analytics application hosted by analytics device 220. Further, assume that a user (e.g., a Telco employee, manager, etc.) of user device 210 may provide input, associated with the network service analytics application, to analytics device 220, and that analytics device 220 may provide output, associated with the network service analytics application, for display via user device 210. Finally, assume that model device 230 (e.g., a Telco model device), associated with the network service management process, stores network service information associated with the Telco network service management process.

For the purposes of FIG. 8A, assume that the user has provided input indicating that the user wishes to view a report, associated with a particular performance metric (e.g., an average repair time) for a particular network service product (e.g., a broadband product) for six regions (e.g., R1 through R6). As shown in FIG. 8A, analytics device 220 may generate (e.g., based on the network service information stored by the Telco model device), a report for the average repair time for the broadband product in regions R1 through R6. As shown, the report may include an end-to-end report (e.g., an overall average repair time) that identifies an average repair time for each region. As shown, the report may also include multiple sub-reports that describe sub-metrics associated with the average repair time metric (e.g., including an average time for tech support associated with a customer service component of the network service management process, an average time for triage associated with a command center portion of the network management process, and an average time to repair associated with a field force component of the network service management process).

As also shown, analytics device 220 may determine (e.g., based on information stored by analytics device 220) a key question associated with the average repair time performance metric (e.g., “How to increase repair speed?”), and may include information that identifies the key question in the report. As further shown, the user may indicate (e.g., by selecting a Metrics Summary button), that the user wishes to view a report that includes a summary associated with multiple performance metrics associated with the Telco network service management process.

As shown in FIG. 8B, assume that the user indicates (e.g., by selecting corresponding radio buttons), that the user wishes to view a report that includes a summary of various performance metrics for the broadband product in region R1 for a three month period (e.g., July, August, September). As shown, analytics device 220 may generate a summary report that includes an average repair time for the broadband product in region R1 for each of the three months, a repeated repair rate for the broadband product in region R1 for each of the three months, an average installation rate for the broadband product in region R1 for each of the three months, and a repair within warranty rate for the broadband product in region R1 for each of the three months. As also shown, analytics device 220 may determine (e.g., based on information stored by analytics device 220) a key question associated with each of the metrics included in the summary report, and may include information that identifies the key question in the report. As shown, the user may indicate (e.g., by selecting a corresponding button) that the user wishes to perform a root cause analysis associated with the “How to decrease repeat repairs?” key question identified in the summary report.

As shown in FIG. 8C, analytics device 220 may begin a root cause analysis, associated with the selected key question, by determining (e.g., based on information stored by analytics device 220) an issue tree associated with the key question. As shown, the issue tree may include the key question (e.g., “How to decrease repeat repairs?”), a first level of queries derived from the key question, a second level of queries derived from the first level of queries, and multiple hypotheses derived from the second level of queries. As shown, the user may indicate (e.g., by selecting a corresponding button) that analytics device 220 is to validate a particular hypothesis (e.g., “The greater the scope of the final test, the less repeat repairs”).

As shown in FIG. 8D, analytics device 220 may perform (e.g., based on network service information stored by the Telco model device) a statistical analysis, associated with the calculating a correlation between the repeat repair rate and the scope of the final test. As shown, assume that analytics device 220 validates the hypothesis based on a statistical analysis indicating that there is a high correlation between repeat repairs and the scope of the final test. As further shown, analytics device 220 may determine (e.g., based on the statistical analysis, based on information stored by analytics device 220) a solution to the “how to decrease repeat repairs?” key question, identified as “increase the scope of the final test to decrease repeat repairs.” As further shown, the user may indicate (e.g., by selecting a corresponding button) that analytics device 220 is to continue the root cause analysis by performing a simulation associated with the solution to the key question.

As shown in FIG. 8E, analytics device 220 may perform (e.g., based on the network service information stored by model device 230) a simulation, associated with the solution to the key question by conducting additional statistical analyses. As shown, the simulation performed by analytics device 220 may include a break-even analysis to determine a financial impact that would be created when different volumes of repeat repairs, to be resolved by network service technicians, pass through the final test. In other words, the break even analysis may determine a volume of repeat repairs to be expected based on different variations of the scope of the final test. As further shown, the user may indicate (e.g., by selecting a corresponding button) that analytics device 220 is to forecast a network service demand, based on a particular final test scope associated with the solution (e.g., 90%), after performing the simulation.

For the purposes of FIG. 8F, assume that the user wishes to view a forecasted network service demand (e.g., a quantity of service orders, including a repeat repairs, to be resolved by network service technicians) for the broadband product in region R1. As shown, analytics device 220 may forecast the quantity of service orders for the broadband product in Region 1. As shown, analytics device 220 may forecast the network service demand based on the solution (e.g., the final test scope of 90%), based on historical network service information (e.g., stored by the Telco model device), and/or based on a weather forecast associated with region R1. As further shown, analytics device 220 may forecast the network service demand for a daily and weekly time period. In some implementations, analytics device 220 may also forecast the network service demand for a monthly time period (not shown). As further shown, the user may indicate (e.g., by selecting a corresponding button) that analytics device 220 is to perform capacity planning based on the forecasted quantity of service orders.

As shown in FIG. 8G, analytics device 220 may perform capacity planning to determine a quantity of network service technicians (e.g., single skilled network service technicians) required to meet the network forecast demand for the broadband product in region R1. As shown, analytics device 220 may perform capacity planning based on the forecasted network service demand (e.g., the quantity of service orders, including repeat repairs, to be expected in region R1) and the network service information (e.g., stored by the Telco model device). As shown, a result of performing capacity planning may include a number of required network service technicians (e.g., for general support (including repeat repairs), for modifications, for cancellations, etc.), a percentage of capacity utilization, and a quantity of forecasted hours. In some implementations, analytics device 220 may proceed with scheduling and dispatching network service resources based on the result of performing capacity planning.

In this way, the network service provider may be provided with a single network services analytics solution that allows for optimization of the Telco network service management process through performance metric reporting, root cause analysis, network service demand forecasting, capacity planning, and scheduling and dispatching the network service technicians based on the results of capacity planning.

As indicated above, FIGS. 8A-8G are provided merely as an example. Other examples are possible and may differ from what was described with regard to FIGS. 8A-8G.

Implementations described herein may provide a network services analytics solution that may allow a network service provider to optimize a network service management process through performance metric reporting, root cause analysis, network service demand forecasting, capacity planning, and scheduling/dispatching of network service resources.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
determine a performance metric associated with a network service management process,
the performance metric being determined based on network service information associated with the network service management process;
determine a key question, associated with the performance metric, based on determining the performance metric,
the key question identifying a business issue associated with improving the performance metric;
perform a root cause analysis, associated with the key question, that identifies a solution to the key question,
the solution identifying a manner in which the network service management process is to be modified in order to improve the performance metric;
forecast a network service demand based on the solution to the key question,
the forecasted network service demand identifying a quantity of future network service actions expected based on implementing the solution within the network service management process;
perform capacity planning based on the forecasted network service demand,
a result of performing the capacity planning identifying network service resources required to satisfy the forecasted network service demand; and
schedule the network service resources, based on the result of performing capacity planning, such that the solution is implemented within the network service management process.

2. The device of claim 1, where the one or more processors are further to:
receive information indicating that the key question corresponds to the performance metric; and
where the one or more processors, when determining the key question, are further to:
determine the key question based on the information indicating that the key question corresponds to the performance metric.

3. The device of claim 1, where the one or more processors, when performing the root cause analysis that identifies the solution to the key question, are to:
determine an issue tree, corresponding to the key question, that includes a hypothesis associated with the key question;
validate the hypothesis based on a statistical analysis of the network service information; and
identify the solution to the key question based on validating the hypothesis.

4. The device of claim 3, where the one or more processors are further to:
receive information indicating that the issue tree corresponds to the key question; and
where the one or more processors, when determining the issue tree, are further to:
determine the issue tree based on the information indicating that the issue tree corresponds to the key question.

5. The device of claim 1, where the one or more processors, when performing the root cause analysis that identifies the solution to the key question, are further to:
perform a simulation associated with the solution,
a result of the simulation identifying a financial impact associated with implementing the solution within the network service management process; and
provide the result of the simulation,
the result being provided to permit a user, associated with the network service management process, to view the result of the simulation.

6. The device of claim 1, where the one or more processors, when performing the root cause analysis, associated with the key question, are to:
identify a first potential solution to the key question;
perform a first simulation associated with the first potential solution,
a result of the first simulation identifying a financial impact associated with implementing the first potential solution within the network service management process;
identify a second potential solution to the key question;
perform a second simulation associated with the second potential solution,
a result of the second simulation identifying a financial impact associated with implementing the second potential solution within the network service management process;
compare the financial impact associated with implementing the first potential solution to the financial impact associated with implementing the second potential solution; and
identify the solution to the key question based on comparing the financial impact associated with implementing the first potential solution to the financial impact associated with implementing the second potential solution,
the solution being the first potential solution or the second potential solution.

7. The device of claim 1, where the one or more processors, when forecasting the network service demand, are to:
determine a group of forecast models associated with forecasting the network service demand;
identify, based on the network service information, a particular forecast model of the group of forecast models; and
forecast the network service demand using the particular forecast model.

8. A method, comprising:
determining, by a device, a performance metric associated with a network service management process,
the performance metric being determined based on network service information associated with the network service management process;
identifying, by the device and based on determining the performance metric, a key question associated with the performance metric,
the key question identifying a business issue associated with improving the performance metric;
identifying, by the device, an issue tree associated with the key question,
the issue tree including a set of hypotheses associated with the key question;
validating, by the device, a hypothesis, of the set of hypotheses, based on the network service information;
determining, by the device, a solution to the key question based on validating the hypothesis,
the solution identifying a manner in which the network service management process is to be modified in order to improve the performance metric; and
performing, by the device, a simulation associated with the solution,
a result of the simulation including financial information associated with implementing the solution within the network service management process; and
outputting the result of the simulation.

9. The method of claim 8, where the hypothesis is a first hypothesis, the solution is a first solution, and the simulation is a first simulation;
where the method further comprises:
validating a second hypothesis, of the set of hypotheses, based on the network service information;
determining a second solution to the key question based on validating the second hypothesis,
the second solution identifying another manner in which the network service management process is to be modified in order to improve the performance metric; and
performing a second simulation associated with the second solution,
a result of the second simulation identifying financial information associated with implementing the second solution within the network service management process.

10. The method of claim 9, further comprising:
comparing the result of the first simulation to the result of the second simulation;
identifying a preferred solution based on comparing the result of the first simulation to the result of the second simulation,
the preferred solution being the first solution or the second solution; and
provide information that identifies the preferred solution.

11. The method of claim 8, where the issue tree comprises:
a set of first level queries associated with the key question; and
multiple sets of second level queries,
a set of second level queries, of the multiple sets of second level queries, corresponding to a first level query of the set of first level queries, and
a second level query, included in the set of second level queries, being associated with one or more hypotheses of the set of hypotheses.

12. The method of claim 8, where validating the hypothesis further comprises:
performing a statistical analysis based on the network performance information; and
validating the hypothesis based on performing the statistical analysis.

13. The method of claim 8, where performing the simulation comprises:
performing a break-even analysis associated with the solution;
performing a regression analysis associated with the solution; or
determining a financial impact associated with the solution.

14. The method of claim 8, where outputting the result of the simulation further comprises:
providing the result of the simulation,
the result being provided to permit a user, associated with the network service management process, to view the result of the simulation.

15. A method, comprising:
generating, by a device, a report associated with a network service management process,
the report including information associated with a performance metric associated with the network service management process,
the performance metric being based on network service information associated with the network service management process;
determining, by the device, a key question, associated with the performance metric, based on generating the report,
the key question identifying a business issue associated with improving the performance metric;
determining, by the device, an issue tree, corresponding to the key question, that includes a hypothesis associated with the key question;
validating, by the device, the hypothesis,
the hypothesis being validated based on a statistical analysis of the network service information;
identifying, by the device, a solution to the key question based on validating the hypothesis,
the solution identifying a manner in which the network service management process is to be modified in order to improve the performance metric;
forecasting, by the device, a network service demand based on the solution to the key question,
the forecasted network service demand identifying a quantity of future network service actions expected based on implementing the solution within the network service management process;
performing, by the device, capacity planning based on the forecasted network service demand,
a result of performing capacity planning identifying network service resources to satisfy the forecasted network service demand; and
scheduling, by the device, the network service resources such that the solution is implemented within the network service management process.

16. The method of claim 15, further comprising:
receiving information indicating that the key question corresponds to the performance metric; and
where determining the key question further comprises:
determining the key question based on the information indicating that the key question corresponds to the performance metric.

17. The method of claim 15, where the issue tree comprises:
a set of first level queries associated with the key question; and
multiple sets of second level queries,
a set of second level queries, of the multiple sets of second level queries, corresponding to a first level query of the set of first level queries, and
a second level query, included in the set of second level queries, being associated with one or more hypotheses of the set of hypotheses.

18. The method of claim 15, further comprising:
performing a simulation associated with the solution,
a result of the simulation identifying information associated with implementing the solution within the network service management process; and
providing the result of the simulation,
the result being provided to permit a user, associated with the network service management process, to view the result of the simulation.

19. The method of claim 18, where performing the simulation comprises:
performing a break-even analysis associated with the solution;
performing a regression analysis associated with the solution; or
determining a financial impact associated with the solution.

20. The method of claim 15, where forecasting the network service demand further comprises:
determining a group of forecast models associated with forecasting the network service demand;
identifying, based the network service information, a best-fit forecast model of the group of forecast models; and
forecasting the network service demand using the best-fit forecast model.
